(19) United States
(12) Patent Application Publication
(10) Pub. No.: US 2007/0187523 A1
(43) Pub. Date: Aug. 16, 2007

(54) Fountain shaping device

(75) Inventor: Gregg Bond, Beverly Hills, CA (US)

Correspondence Address: YING CHEN, 255 S. GRAND AVE., # 215, LOS ANGELES, CA, 90012, US

(73) Assignee: The Helman Group, Ltd.

(21) Appl. No.: 11/357,873

(22) Filed: Feb. 16, 2006

(51) Int. Cl. F21S 8/00

(52) U.S. Cl. 239/18

(57) ABSTRACT

A fountain shaping device is provided, which can make a food fountain with different flavors and/or colors simultaneously. The fountain shaping device includes at least one motor, a transmission mechanism coupled to the motor, a holding tray and a fountain maker. The fountain maker includes a tube mounted on the holding tray through a positioning unit, at least one tier mounted to the tube, and at least two augers located in the tube, which are respectively coupled to and driven by each output end of the transmission mechanism. The number of the output ends is equal to that of the augers. Since there are the at least two augers and the food materials are kept separated during the operation, a food fountain with different flavors can be formed.

### BACKGROUND OF THE INVENTION

1. Field of the Invention

The present invention relates to a fountain shaping device, and particularly to a fountain shaping device used for fluid food.

2. Description of the Related Art

Various parties or banquets are increasing in the modern social life, and many kinds of apparatuses used for making food in various shapes appear, so as to amaze guests or attract peoples' attention in the parties. One of such apparatuses is a fountain shaping device for fluid food (such as melted chocolate). Using the fountain shaping device, chocolate cascades off of round tiers and forms a fountain. This makes delicious treats for guests, and guests may dip fruit, pretzels, cookies and other accompaniments into the warm flowing chocolate. However, the fountain shaping device on the market can only make a fountain with one flavor or color. Even if using various food materials, the fountain shaping device simply mixes them up and makes a fountain with a mixed flavor. Thus, it would be desirable to provide a fountain shaping device which can separate different food materials and make a food fountain with different flavors or colors simultaneously.

### SUMMARY OF THE INVENTION

It is an object of the present invention to provide a fountain shaping device which can make a food fountain with different flavors and/or colors simultaneously.

According to one aspect of the present invention, a fountain shaping device includes: at least one motor, a transmission mechanism coupled to the at least one motor, a holding tray and a fountain maker, wherein the fountain maker comprises a tube element mounted on the holding tray, and at least one flange tier configured on the tube element, and at least two auger elements positioned in the tube, which are respectively coupled to and driven by output ends of the transmission mechanism, wherein the number of the output ends is equal to that of the auger elements. The at least two augers are separated by at least a dividing member in the tube. With assistance of additional separating element in the holding tray and the extended portion of the dividing member outside the tube, the different food materials can be separated in operation. Therefore, by maintaining the fluid food materials separate during use, the fountain shaping device makes a food fountain with different flavors and/or colors simultaneously, and permits the user to select different flavors and/or colors.

Another object of the present invention is to provide an improved fountain shaping device, which is easy to assemble, use and clean.

According to another aspect of the present invention, a bottom portion of the central spindle of each of the augers has a socket hole, each with a shape and length fitting an upper portion of each output end of the transmission mechanism above the holding tray. A bottom portion of the tube is socketed with a fastening element, which comprises three cylindrical plugholes around the bottom portion of the tube. With this kind of structure in the auger and the fastening element at the bottom of the tube, the auger and the tube are easily disassembled for cleaning.

A further object of the present invention is to provide an improved fountain shaping device with a simple structure and a compact design.

According to still another aspect of the present invention, the transmission mechanism further comprises a gear set and at least one input end coupled to the at least one motor. In a preferred embodiment, the fountain shaping device has two augers and the transmission mechanism has two drive rods respectively coupled to the two augers. The gear set includes 5 gears: a first gear coupled to a motor through the input end, two second gears being coaxial with the drive rods and two cascade gears engaged with the first gear. Thus this gear set only needs one motor to operate. Both of the two cascade gears comprise an upper gear and a lower gear, and the two second gears are located at different height, thus they overlap one another to save space, while each of the second gears are respectively driven by the upper gear of each cascade gear. The motor drives the transmission mechanism to operate, thus drives the augers to rotate.

### BRIEF DESCRIPTION OF THE DRAWINGS

For a full understanding of the invention, the embodiments of the present invention will now be described with reference to the accompanying drawings, in which:

FIG. 1 is a front view of a fountain shaping device according to a preferred embodiment of the present invention;

FIG. 2 shows two augers located in the fountain maker according to a preferred embodiment of the present invention;

FIG. 3 shows a more detailed embodiment of a fountain shaping device according to the embodiment of the present invention in FIG. 2;

FIG. 4 shows the internal structure of an opened gearbox according to a preferred embodiment of the present invention;

FIG. 5 is a side perspective view of the opened gearbox in FIG. 4; and

FIG. 6 shows a fountain shaping device with two augers as shown in FIG. 2, creating a chocolate fountain in two different colors and/or chocolate materials.

### DETAILED DESCRIPTION OF THE PREFERRED EMBODIMENTS

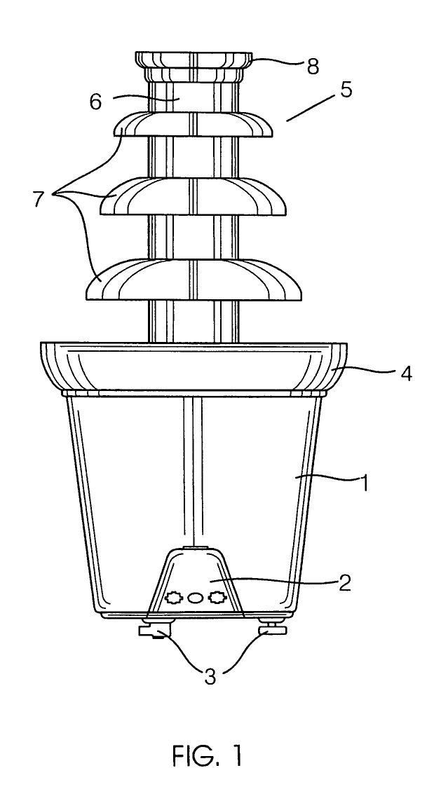

Referring first to FIG. 1, a fountain shaping device according to an embodiment of the present invention is shown. The fountain shaping device comprises a housing 1, a switch-control panel 2 on the housing 1, a base support 3, a holding tray 4, and a fountain maker 5. At least one motor and a coupling gearbox are located within the housing 1. The gearbox contains a transmission mechanism which has at least one input end and at least two output ends.

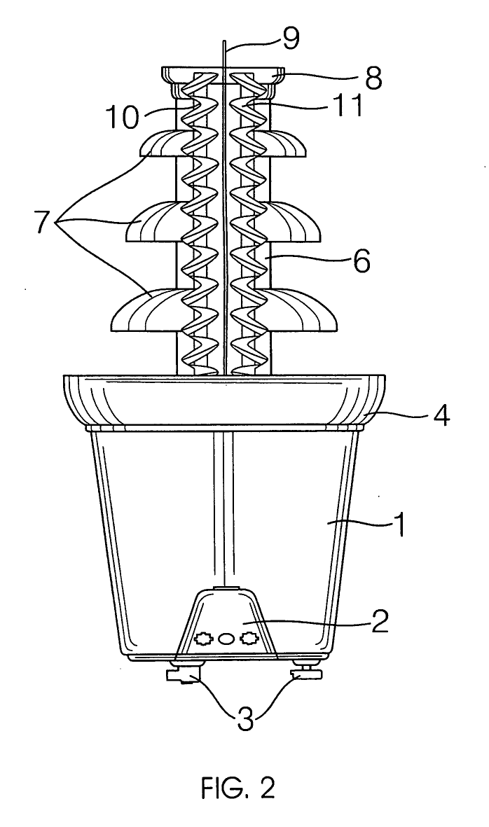

As shown in FIG. 1, the fountain maker 5 comprises a sleeve element or tube 6, with three arch-shaped flanges or round tiers 7 mounted (such as by welding) or integrated on the tube 6. Each tier is spaced apart with one another and the top tier is also spaced from the upper opening of the tube 6. The diameter of the tiers 7 is increased from the upper to the lower, and the diameter of the top tier is larger than that of the upper opening of the tube 6 to make a fountain. The number of the tiers can be selected as desired. Further, the shape of the tiers may be formed in other shapes. The fountain maker 5 further comprises at least two augers located in the tube 6, which are separated by at least one dividing member (See FIG. 2). The tube 6 is removably secured to the holding tray 4 while the augers are removably secured to the output ends of the gearbox through the holding tray 4, thus they are easily disassembled for quick cleaning. The number of output ends of the transmission mechanism is equal to that of the augers, and the output ends are respectively coupled to each of the augers. The number of the input ends of the transmission mechanism is equal to that of the motors. There is also a heater in the housing 1, for heating the liquid food on the holding tray 4 and maintain its temperature. There are three switches and corresponding indicator lights on the switch-control panel 2, with one switch controlling the motor and two switches controlling the heater's state: heating or maintaining temperature.

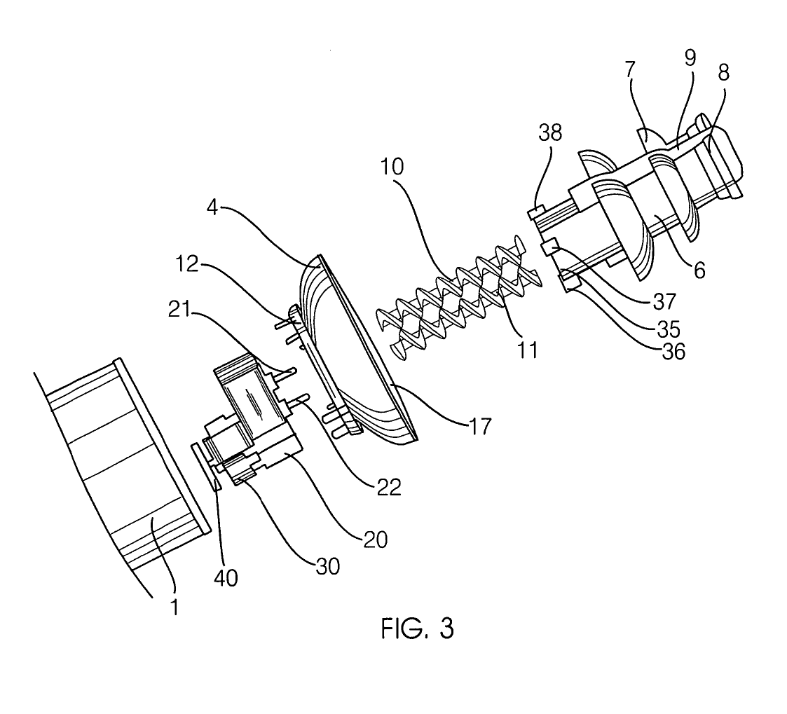

As shown in FIG. 2, there are two auger elements or augers 10 and 11 in the tube-shaped element or tube 6 in a preferred embodiment of the present invention. The auger is a one-piece structure with a spiral on it. The two augers 10 and 11 are separated by a dividing plate 9 inside the tube 6. The dividing plate 9 can be further configured to extend outwardly to form an outside portion on each side of the tube 6 for separating the different fluid materials outside the tube 6 (as shown in FIG. 3). Optionally, the two augers may be separated by other means. For example, there may be two tubes, and each contains one auger. There is further provided with a corresponding separator or separating plate on the holding tray 4 to separate the food materials, as shown in FIG. 3. Since there are two augers in a separated space, the food materials are kept separated during the operation and are driven to the top of the tube separately. Thus, a fountain with two favors or colors cascades down.

FIG. 3 is a more detailed view of the fountain shaping device as shown in FIG. 2 according to the present invention. The fountain shaping device contains two augers 10 and 11, thus its transmission mechanism has two output ends (i.e. drive rods 21 and 22). As shown in FIG. 3, the components under the holding tray 4 are a heater 12, a gearbox 20 and two drive rods 21 and 22 extending out from the gearbox, a motor 30, as well as a fan 40 in turn. The heater 12 is annular, and there are eight integrally formed screw threads at the bottom of the holding tray or at the edge of the heater for receiving locking members, so as to be fixed in the housing 1. The heater 12 is mounted against the bottom surface of the holding tray 4, such as by screws or nails. The output ends of the motor 30 connect to the input end of the transmission mechanism and the fan 40 which are driven by the motor 30. The motor 30 drives the two drive rods by driving the transmission mechanism inside gearbox 20. Each bottom portion of the central spindle of the augers 10 and 11 has a socket hole, each with a shape and length matching the upper portion of each drive rod. By this way, the upper portions of the drive rods 21 and 22 extending through holes of the heater 12 and the holding tray 4, respectively and removably connect to augers 10 and 11, and drive them to rotate. And with this structure, the augers are easily disassembled for cleaning. The space between the holding tray 4 and side upper surfaces of the drive rods 21 and 22 is sealed by ring seals or other structures.

The fountain shaping device further comprises a fastener mechanism for fixing the tube element onto the holding tray. The bottom portion of the tube 6 is provided with a fastening element 35, and the top portion of the tube includes an upper opening 8 in a bowl shape. The fastening element 35 includes three cylindrical plugholes 36, 37 and 38, which are spaced apart from each other around the bottom of the tube 6 and formed integrally on bottom of the tube. There are three positioning rods arranged on the holding tray 4, matching the plugholes of the tube 6 in shape. The positioning rods each comprises a lower portion fixed on the holding tray 4 and an upper portion to be received by each of the plugholes, and the diameter of the lower portion is larger than that of the upper portion (not shown). Thus, there is a certain distance between the bottom of tube 6 and the upper surface of the holding tray 4. This distance allows the food materials on the holding tray 4 to easily enter into the tube 6. With the fastener, the tube 6 is mounted onto the holding tray 4 detachably. In addition, the positioning rods may also act as nuts fitting the screws to fix the heater 12 and themselves on the holding tray 4. As shown in FIG. 3, the holding tray 4 is further provided with a separator or separating plate 17 positioned at the middle of the tray 4 for separating the two different food materials in cooperation with the dividing plate 9. At the lower portion of the tube 6 is provide with two opposite cuts facing each outside portion of the dividing plate 9 for receiving the separator 17.

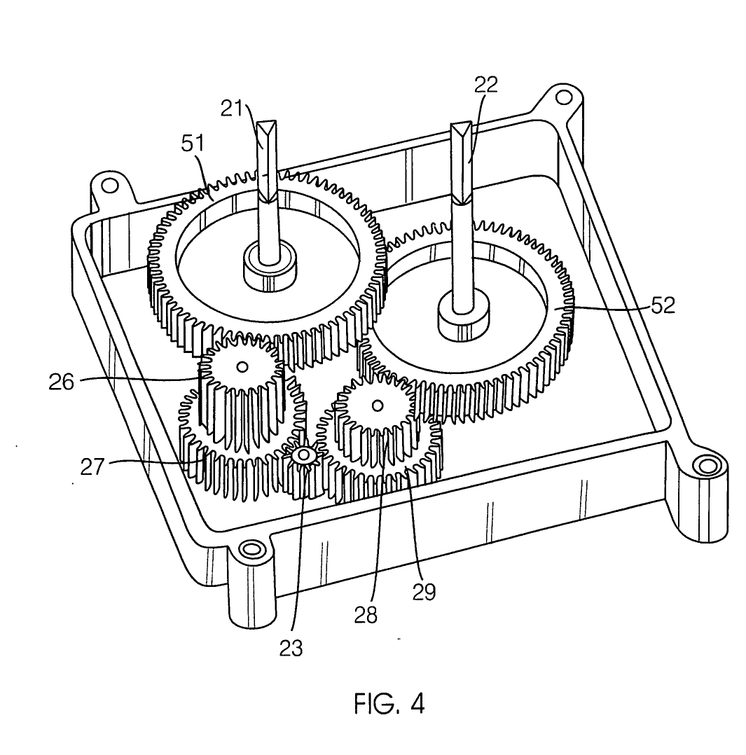

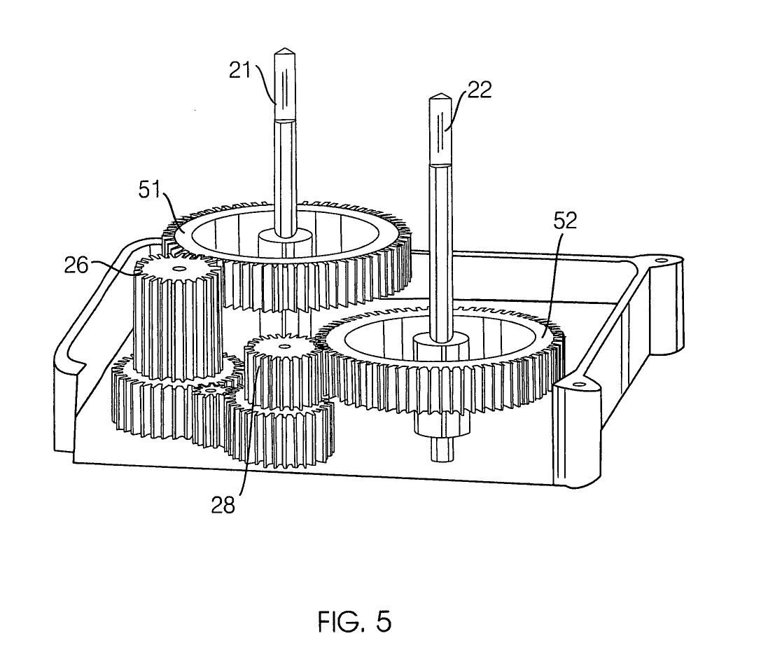

FIG. 4 shows an opened gearbox according to a preferred embodiment, which contains a transmission mechanism. As shown in FIG. 4, the transmission mechanism includes a gear set which consists of 5 gears: a first gear 23, two cascade gears 24 and 25 engaged with the first gear 23, and two second gears 51 and 52 respectively being coaxial with two drive rods 21 and 22. Each of two cascade gears 24 and 25 further comprises two gears in one-piece: an upper gear 26 and a lower gear 27, an upper gear 28 and a lower gear 29. The diameter of both upper gears is less than that of both lower gears. And the length of the upper gear 26 is longer than that of other upper gear 28. Additionally, as shown in FIG. 5, two second gears 51 and 52 are at different heights, with the second gear 51 higher than the second gear 52. Thus two second gears 51 and 52 overlap each other in the space to save space and make the transmission mechanism more compact. The higher second gear 51 engages with the longer upper gear 26, and the lower second gear 52 engages with the shorter upper gear 28. Therefore the transmission mechanism just needs one motor to operate. The first gear 23 is driven by the motor and in turn the first gear 23 drives two cascade gears 24 and 25 to rotate, and then two second gears 51 and 52 and their coaxial two drive rods 21 and 22 are respectively driven to rotate, thus making two augers 10 and 11 rotate in the same direction. The food materials on the holding tray 4 are then fed up to the top of the tube 6 by the tow augers.

In another preferred embodiment, another transmission mechanism can be used. This transmission mechanism is similar to the one in FIG. 4, but without the first gears 23. Thus this transmission mechanism needs two motors to operate. Two cascade gears 24 and 25 are respectively driven by the two motors, and in turn two second gears 51 and 52 and their coaxial two drive rods 21 and 22 are respectively driven to rotate, thus making two augers 10 and 11 rotate.

In a variation of the above embodiments, there can be more than two augers (such as three or more) separated by proper dividing and separating members on the tube and on the holding tray. And the number of the output ends of the transmission mechanism is the same as the augers. The number of the motors driving the transmission mechanism can be one or is corresponding to that of the augers, and the change of the transmission mechanism is the change in the number of the gears.

The rotation speed of motor used here can be about 3000/min, and the reduction rate of the transmission mechanism is suitable to make the augers driven by it have suitable rotation speed, thus achieving desired effect of the food fountain. In a preferred embodiment, the auger can be molded by durable heat-resistant plastic, and the tube, the tier and the holding tray can be made of stainless steel.

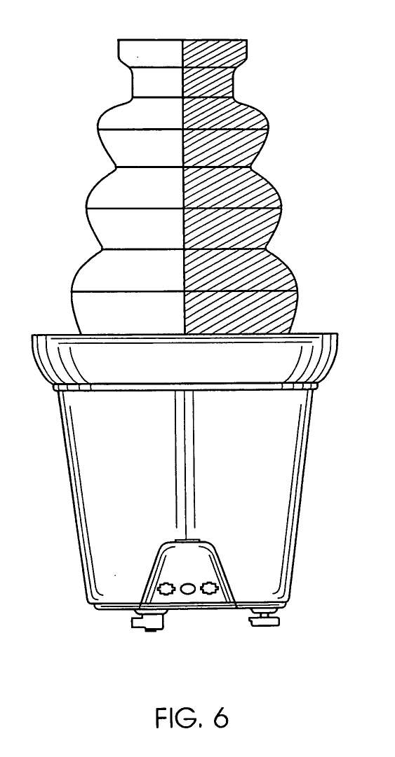

FIG. 6 shows the effects of a chocolate fountain shaping machine as shown in FIG. 2. To make the fountain, first pour the different food materials (such as black chocolate and white chocolate) respectively into each of the separated part of the holding tray, then turn on the heating switch to melt the chocolate into liquid (or you can first melt the chocolate in other heating unit and directly pour the liquid chocolate onto the holding tray). Then turn on the switch of keeping warm to keep the chocolate in liquid state, and turn on the switch of the motor to make it operate. During the operation, the augers are driven to rotate, thereby pushing the chocolate upwards to the tube and to the top bowl of the tube. When the bowl shaped top is full, the chocolate overflows and cascades down the tiers and back into the holding tray where the process starts all over again. Since black and white chocolate are used, and they are kept separated during the operation, the chocolate fountain in black and white colors (with two flavors) is formed.

The foregoing descriptions of embodiments of the invention have been presented for purposes of illustration and description only. They are not intended to be exhaustive or to limit the invention to the forms disclosed. Many modifications and variations will be apparent to those skilled in the art without departing from the basic scope thereof. Accordingly the scope of the invention is defined by the appended claims.

What is claimed is:

1. A fountain shaping device comprising:
at least one motor;
a transmission mechanism coupled to the at least one motor;
a holding tray; and
a fountain maker,
wherein the fountain maker comprises a tube element mounted on the holding tray, and at least one flange tier configured on the tube element, and at least two auger elements positioned in the tube, which are respectively coupled to and driven by output ends of the transmission mechanism, wherein the number of the output ends is equal to that of the auger elements.

2. The fountain shaping device of claim 1, wherein the at least two auger elements are separated by at least one dividing member in the tube element, and thereby each of the auger elements is disposed in a space separated from others.

3. The fountain shaping device of claim 2, wherein each of the auger elements includes a central spindle with a bottom portion formed with a socket hole, wherein each socket hole has a shape and length adapted to fit the upper portion of each output end of the transmission mechanism passing through the holding tray.

4. The fountain shaping device of claim 3, further comprising a fastener for fixing the tube element onto the holding tray.

5. The fountain shaping device of claim 4, wherein the fastener comprises three or more plugholes configured on a bottom portion of the tube, and a positioning unit including three or more positioning rods positioned on the holding tray and respectively matching the plugholes in shape, and wherein the plugholes and the positioning rods are spaced apart correspondingly so that at least a portion of each of the positioning rods can be inserted into one of the plugholes.

6. The fountain shaping device of claim 1, wherein the transmission mechanism further comprises a gear set and at least one input end coupled to the at least one motor, wherein the number of the input ends is equal to that of the motors.

7. The fountain shaping device of claim 1, wherein the number of the auger elements is two, and the output ends of the transmission mechanism are two drive rods coupled respectively to the two auger elements.

8. The fountain shaping device of claim 7, wherein the number of the motors and the input ends of the transmission mechanism is one, and the gear set includes a first gear coupled to the motor through the input end, two second gears respectively being coaxial with the drive rods and two cascade gears engaged with the first gear.

9. The fountain shaping device of claim 7, wherein the number of the motors and the input ends of the transmission mechanism each is two, and the gear set includes two cascade gears respectively coupled to the two motors through two input ends and two second gears respectively being coaxial with the drive rods.

10. The fountain shaping device of claim 8, wherein both of the two cascade gears comprise an upper gear and a lower gear, and the two second gears are located at different height and overlap one another, wherein each of the second gears respectively engages with the upper gear of each cascade gear.

11. The fountain shaping device of claim 9, wherein both of the two cascade gears comprise an upper gear and a lower gear, and the two second gears are located at different height and overlap one another, wherein each of the second gears respectively engages with the upper gear of each cascade gear.

12. The fountain shaping device of claim 1, further comprising a heater positioned against the bottom surface of the holding tray for heating the food materials on the tray and maintaining their temperature.

13. The fountain shaping device of claim 12, wherein the heater is in a ring shape.

14. The fountain shaping device of claim 1, further comprising at least one separating element configured on the upper surface of the holding tray for separating different materials in the holding tray.

15. The fountain shaping device of claim 2, wherein the at least one dividing element extends outwardly from inside of the tube element to form outside portions for dividing the different materials flowing down from an upper opening of the tube element.

16. The fountain shaping device of claim 14, wherein the tube element further include at least two cuts at its lower portion to receive said separating element on the holding tray.

17. The fountain shaping device of claim 2, wherein the tube element is detachably fixed on the holding tray.

18. The fountain shaping device of claim 1, wherein the auger elements are detachably connected to the output ends of the transmission mechanism.

19. A fountain shaping device comprising:
at least one motor for providing driving power;
a holding tray; and
a fountain maker, wherein the fountain maker comprises a tube element mounted on the holding tray, and at least one flange tier configured on the tube element, and at least two auger elements positioned in the tube element and driven by the power of the motor.
